(19) United States
(12) Patent Application Publication
(10) Pub. No.: US 2007/0294905 A1
(43) Pub. Date: Dec. 27, 2007

(54) Carpenters bracket attachment pencil holder

(76) Inventor: John Whittenburg, St. Clair Shores, MI (US)

Correspondence Address: John Whittenburg, P.O. Box 806123, ST Clair Shores, MI, 48080, US

(21) Appl. No.: 11/301,321

(22) Filed: Mar. 23, 2006

(51) Int. Cl. B43K 29/18

(52) U.S. Cl. 33/760

(57) ABSTRACT

The over all length of 4″ inches of the pencil holder attachment with two way tape (15) then taking off exposed side of tape (14) then mounting on tape measure then inserting pencil in (16) then turning thumb screw (11) then setting tape measure at desired mark looking at indicator (17) using both hands moving the tape extended either down or across wood boards, paneling, or drywall marking a straight line. My invention is a carpenter's pencil holding bracket that is attached to most recoil tape measures. The bracket which is 5 inches full length and 1⅜ inches wide is mounted a half inch from the bottom of the tape measure. The flat part of the pencil holder is attached with a two way cushion attachment tape. With the off set of the pencil holder extended past the front of the tape therefore being able to extend the tape measure on desired foot mark or inch mark. With lock tape measure then move both hands either across or down the board or paneling or drywall to make a straight line for the purpose of cutting off excess material not needed. My invention does away with the usage of holding a pencil by the tape measure and trying to make a straight line. Also, my attachment does away with making a mark on the material and then picking up a carpenter's square or a straight edge to mark a straight line to go across or down in order to cut it off. There are a lot of times that material is miscut and wasted. With my invention time lost on the job and material wasted will add saved time and the waste of material whether it be lumber, drywall, paneling, or other materials. Trying to hold a pencil by the tape measure with one's hand at the same time holding the tape measure to make a straight line across or down the panel or piece of lumber is a primitive way of trying to do the job correctly.

### CROSS-REFERENCE TO RELATED APPLICATIONS

No reference to prior method.

### FEDERALLY SPONSORED RESEARCH

Not Applicable

### SEQUENCE LISTING OR PROGRAM

Not Applicable

### BACKGROUND OF INVENTION—FIELD OF INVENTION

This invention enables user to make a straight line on any flat material to be cut off. Users have to mark drywall or wood at the top and bottom and then use a square or straight edge to draw a line between the top and bottom marks.

This invention relates to measuring and marking measurements on paneling, drywall, or lumber in the construction or related fields.

### BACKGROUND OF INVENTION—PRIOR ART

Carpenters, people in drywall make a mark on the lumber, paneling, drywall holding a pencil with their fingers while also holding the tape measure to make a straight line. In the construction field trying to make a straight line holding a pencil and a tape measure in one hand is a primitive way. Up to the time of my invention that's the way it's been done. Time is lost because of the fact that they go off the mark then they cut the board or piece of lumber. They have to start all over now. They have lost and wasted good material and lost time on the job. Not only is time and material lost and wasted the frustration sets in for the tradesman. Other ways that carpenters and drywall workers, along with electricians, make and mark a straight line is by measuring their material then get a straight edge or a carpenter's square to mark a straight line. The disadvantage to a straight edge or carpenter's square is they are not always right there. Therefore, that's where there is lost time, also using the current method you put the pencil down or in your pocket go look for the square or straight, also when measuring and marking a piece of 4′×8′ panel or 4′×8′ drywall a square won't be long enough if you don't have a straight edge you have to find a piece of lumber that is straight or a flat piece of metal that will go the 4 feet or 8 feet. My invention will go the 4 feet way or the 8 foot way. My invention will aide the tradesman and even the home owner in making work and projects easier.

### BACKGROUND OF INVENTION—OBJECTS AND ADVANTAGES

Accordingly, besides the objects and advantages of the carpenters pencil holder bracket attachment in my above patent, several objects and advantages of the present invention are:

(a) To provide and attachment to a tape measure that will mark a straight line;

(b) To provide an attachment that is simple to attach to a tape measure;

(c) To provide an easy way for anyone to be able to mark a straight line without having a straight edge or carpenters square;

Further objects and advantages are to provide a tool attachment which can be installed easily and very simple to use. With a carpenters pencil installed and the two way tape already attached it is easy to attach to a tape measure and very easy to use. My invention is to aid and the job or project easier.

### SUMMARY

In accordance with the present way of marking a straight line on paneling, drywall, and lumber, making a mark at the top of the paneling or piece of lumber and at the bottom then either with a straight edge or by holding a pencil and the tape measure in one hand to draw a straight line at the mark desired.

### DRAWINGS—FIGURES

In the drawings, the figures have the same numbers for the same part but at different angles and different views apply.

FIG. 1 shows a top view looking down at the top of the pencil holder.

FIG. 2 shows the obverse side from FIG. 1 or side.

FIG. 3 shows the front view end where the pencil is inserted.

FIG. 4 shows reverse side with two way tape attached.

FIG. 5 shows FIG. 5 in FIG. 1 with exception showing a top view of bracket mounted to tape measure.

FIG. 6 shows side view of bracket mounted to tape measure with pencil inserted.

FIG. 7 shows front of pencil holder with pencil inserted.

### DRAWINGS—Reference Numerals

11 10-24 thumbscrew
12 gusset front side
13 gusset back side
14 two way attachment tape
15 mounting attachment bracket
16 hole for pencil
17 measurement notch
18 attachment side of bracket
19 pencil in hole of bracket

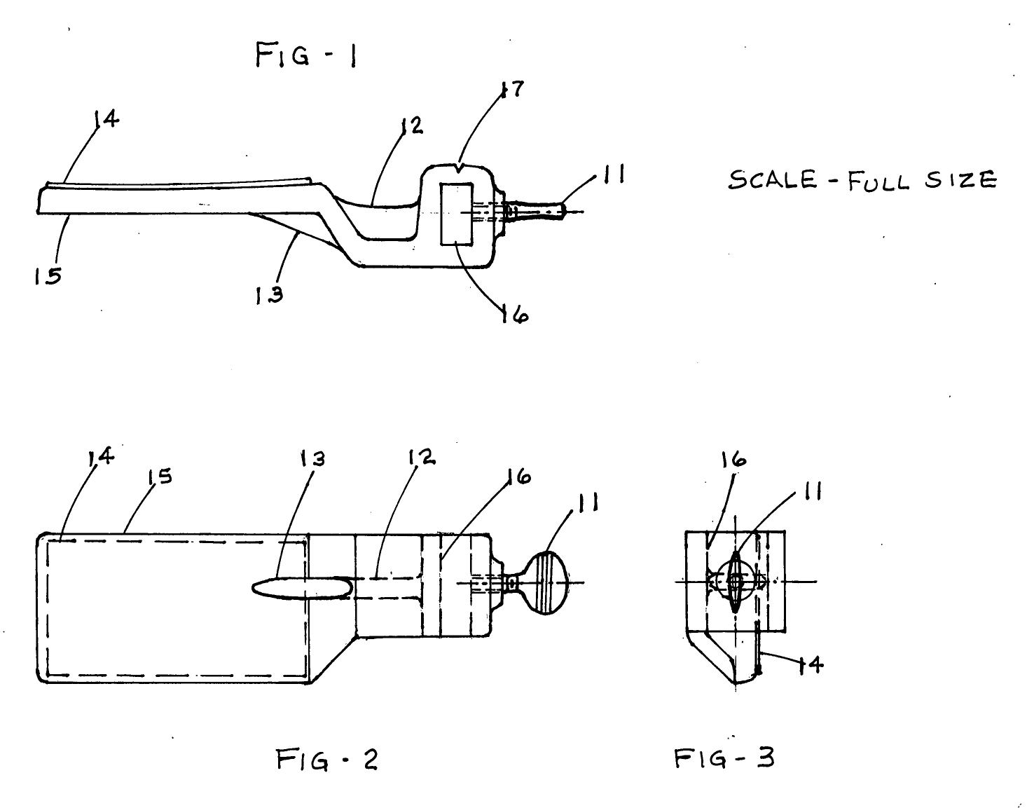

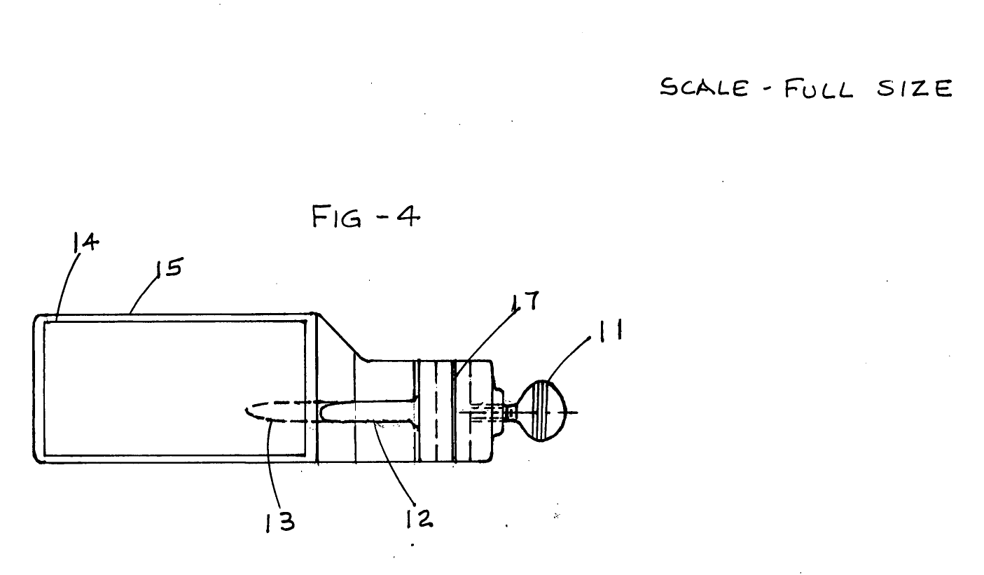

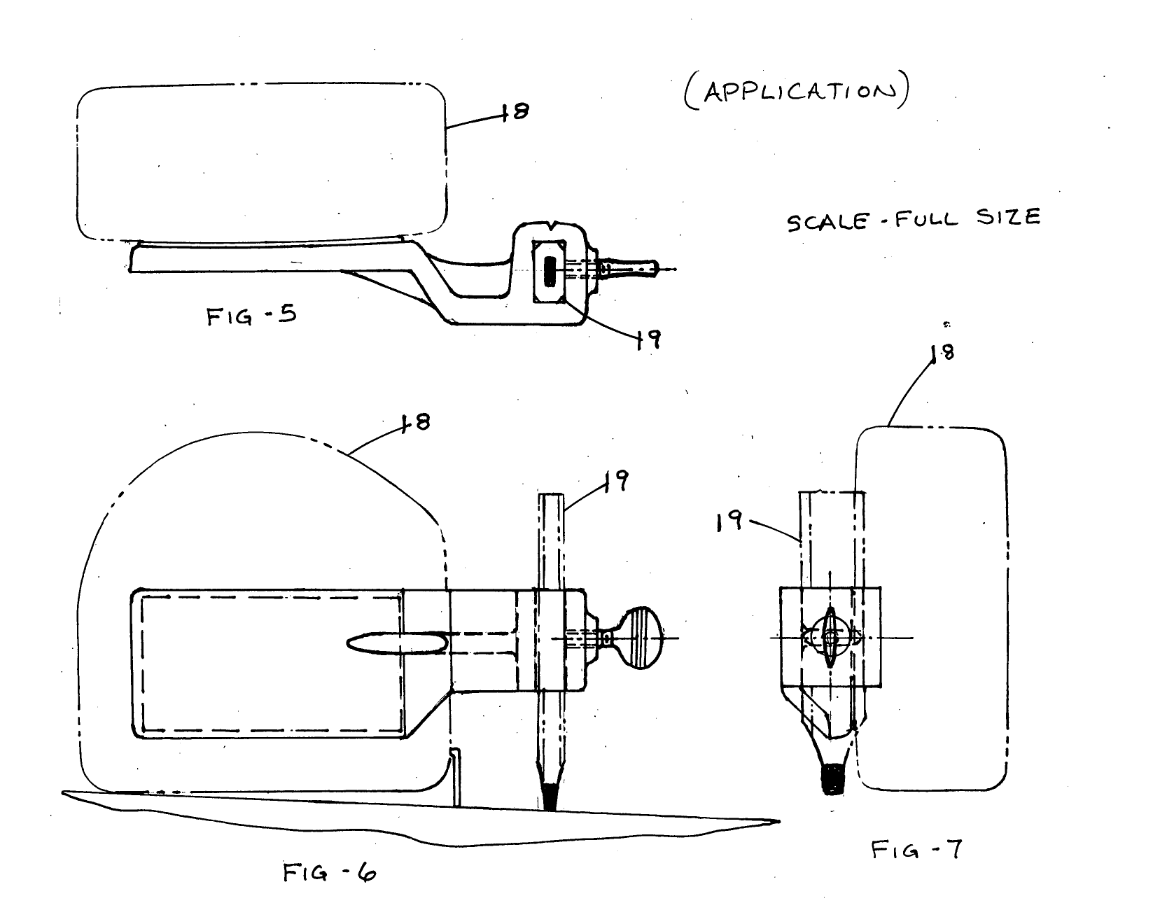

### DETAILED DESCRIPTION—FIG. 1

The manner of operation and attaching carpenters pencil holder is a two way tape, industrial type. Two way tape is attached when pencil holder is made. When attaching bracket to tape measure exposed side has the peel away paper. When removed glue is activated to hold and adhere to tape measure FIG. 1 14. When tape is extended to desired mark on tape, indicator mark FIG. 1 17 lines up with desired mark with both hands pulling down or sideways draws the line straight. FIG. 2 showing the body of the attachment 15 is big enough to be able not to come off. With gusset 13 making attachment stronger along with gusset 12 in FIG. 2 it is flexible enough that when dropped will not break.

1. Pencil holder attachment is a tool when attached to a tape measure marks a straight line on lumber, dry wall, paneling, and roofing material.

2. Removing carpenter's pencil then installing small utility knife will cut drywall and cut roofing material with a straight line.
